(19) United States
(12) Patent Application Publication
(10) Pub. No.: US 2004/0207459 A1
(43) Pub. Date: Oct. 21, 2004

(54) Charge pump bypass

(75) Inventors: Thomas Farkas, Marlborough, MA (US); Abram P. Dancy, Shrewsbury, MA (US); Leif E. LaWhite, Thetford, VT (US); Martin F. Schlecht, Lexington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SynQor, Inc., Boxborough, MA

(21) Appl. No.: 10/764,997

(22) Filed: Jan. 26, 2004

Related U.S. Application Data
(63) Continuation-in-part of application No. 10/763,820, filed on Jan. 23, 2004.
(60) Provisional application No. 60/453,423, filed on Mar. 7, 2003.
(60) Provisional application No. 60/525,058, filed on Nov. 25, 2003.

(51) Int. Cl. G05F 3/02

(52) U.S. Cl. 327/536

(57) ABSTRACT

A charge pump circuit in a gate controller provides a pumped gate control voltage to switches of a DC/DC converter. Different input voltages may be applied to the controller and an input voltage higher than the charge pump output could result in circuit damage. A clamp circuit between the input and output prevents the output voltage from being significantly below the input voltage to prevent such damage. The clamp circuit may be a transistor controlled by a comparator or amplifier.

### RELATED APPLICATIONS

This application is a continuation-in-part of U.S. Application identified by Attorney Docket No. 1465.2009-002 entitled “Charge Pump Bypass” filed on Jan. 23, 2004 with Thomas Farkas, Abram P. Dancy, Leif E. LaWhite and Martin F. Schlecht as inventors, which claims the benefit of U.S. Provisional Application Nos. 60/453,423, filed on Mar. 7, 2003 and 60/525,058, filed on Nov. 25, 2003. The entire teachings of the above applications are incorporated herein by reference.

### BACKGROUND OF THE INVENTION

Power converters, such as non-isolated DC/DC down converters, are often built using integrated control circuits. These control IC's direct the operation of the power converter's power stage, and they implement various control functions that are required to create a well-behaved power converter under all operating conditions.

One such control function provided by some control IC's is that of a bias supply to provide power to the controller's internal circuitry and to the driver of the power MOSFET gates. The Intersil ISL6526, for example, is specified to operate from supplies of 3V to 5.5V. When operated from supplies of 3V to 3.6V, a bias supply in the form of an internal charge pump is used to generate the higher voltages required for the IC's internal circuitry and for a gate drive voltage that will result in full enhancement of the power MOSFETs. When operated from supplies of 4.5V to 5.5V this charge pump is bypassed and the internal circuitry is powered directly from the input voltage supply.

### SUMMARY OF THE INVENTION

Modern DC/DC converter applications desire to be able to operate over ever-wider supply voltage ranges. The Intersil ISL6526 mentioned above, however, requires that it be configured in two different arrangements depending upon the supply voltage: charge-pump active for low supply voltages, or charge-pump bypassed for higher supply voltages. This would normally require converter manufacturers to design, manufacture, and support two different products: one for ˜3.3V (low) input voltage supplies and another for ˜5V (high) input voltage supplies. It also requires that converter customers select, approve, and inventory one, or probably both, of those offerings.

Market forces desire to achieve proper operation over the entire supply range with the identical product, minimizing the design, approval, and inventory costs of multiple similar converters. To gain market acceptance, the converter should re-configure itself to operate properly over a wide range of input voltage. This document describes circuitry which, when added to a control IC such as the ISL6526, allows it to operate correctly over its entire specified input voltage supply range. The circuitry automatically reconfigures the bias supply in the PWM IC to operate not only in the low and high voltage regimes, but also throughout the continuum between.

Though construed for the ISL6526, the essence of this invention is applicable with other control ICs as well.

In embodiments of the invention, a charge pump circuit includes a charge pumping capacitance and switches that vary voltage across the pumping capacitance to provide a pumped output voltage from an input voltage. A clamp circuit between the input and output prevents the output voltage from being significantly below the input voltage. Where the charge pump is included in a controller, the clamp can prevent the output voltage from being below the input voltage by an amount which would cause the controller to malfunction. In a typical application, the output voltage would be clamped to be no more than 0.2 Volt below the input voltage.

The clamp circuit may comprise a transistor such as a field effect transistor. The transistor may be controlled by a comparator which may exhibit hysteresis. Alternatively, the transistor may be controlled by an amplifier.

A particular application of the invention is in a DC/DC converter in which the pumped output voltage is applied to a controller that controls converter switches.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1, Intersil ISL6526 PWM IC Block Diagram

FIG. 2, Charge Pump Internal Switches

FIG. 3a, ISL6526 Configured for Operation near 3.3V in.

FIG. 3b, ISL6526 Configured for Operation near 5.0V in.

FIG. 4, ISL6526 With Clamp, Configured for Wide-Range Input Voltage

FIG. 5, Clamp Implemented with a Schottky Diode

FIG. 6, Simple Amplifier-Controlled Bipolar Clamp

FIG. 7, Adjustable Amplifier-Controlled Bipolar Clamp

FIG. 8, Amplifier-Based Clamp with MOSFET

FIG. 9, Comparator-Based Clamp with MOSFET & Hysteresis

FIG. 10, Implementation of Clamp Circuit

FIG. 11, Implementation with Explicit Offset

FIG. 12, Implementation of Circuit

FIG. 13, Normally-on Clamp Circuit

FIG. 14, Normally-on Clamp Aiding Tolerance Issue of Resistor Dividers

FIG. 15, Amplifier & Reference Based MOSFET Clamp

### DETAILED DESCRIPTION OF THE INVENTION

A description of preferred embodiments of the invention follows.

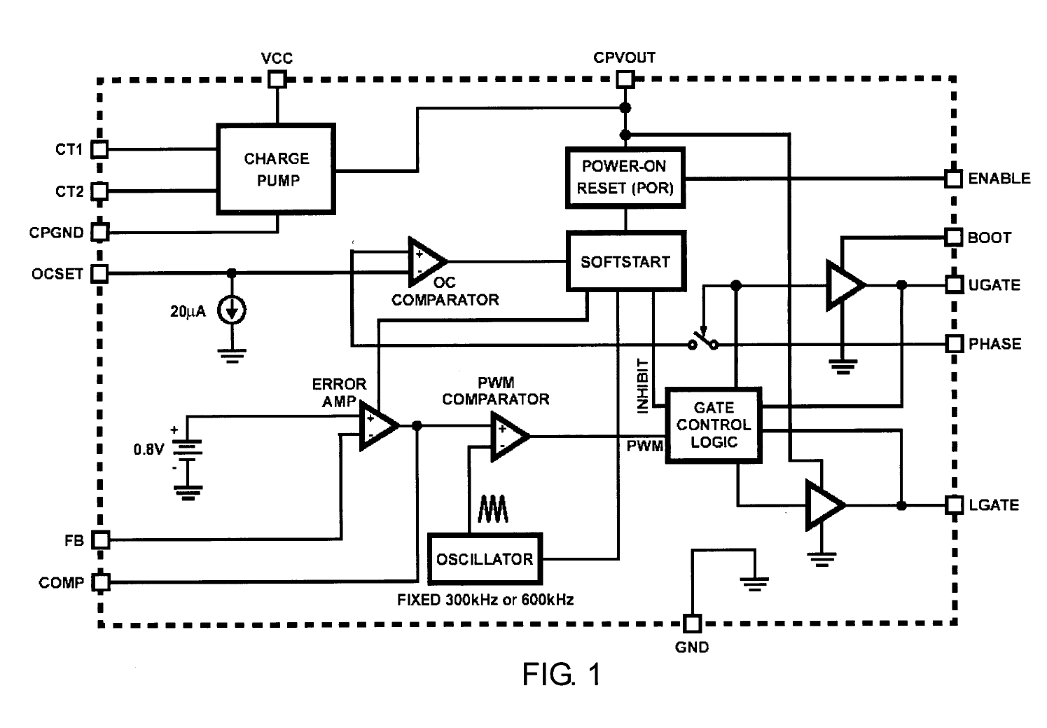

FIG. 1 shows the internal block diagram of the Intersil ISL6526. This control IC is intended for use in constructing synchronous buck DC/DC converters. Input power, Vin, is supplied to the IC via the Vcc pin. Pins Ugate and Lgate drive gates of external power MOSFETs. The IC also contains an internal reference, an error amp, an oscillator, and most of the other circuitry required to perform PWM-controlled switching of the external power MOSFETs.

Since this IC is intended to operate from relatively low supply voltages, it also contains the switches to implement a charge pump. This charge pump is used to (optionally) raise the IC's internal supply voltage, CPVout, higher than Vin. This is required, in this instance, to properly power the remainder of IC's internal circuitry and to fully enhance external power MOSFETs.

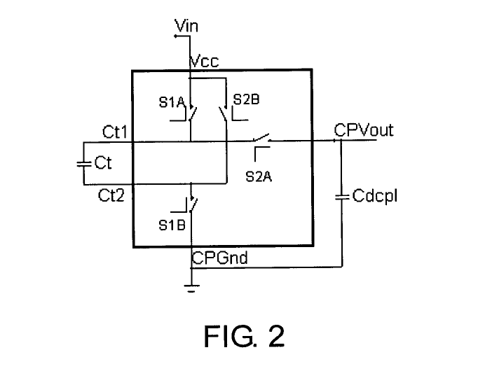

The internal switches comprising the charge pump are as depicted in FIG. 2. For the purposes of this discussion the charge pump is a standard 4-switch charge pump, but any charge pump may be used. When switches S1A and S1B are closed, pumping capacitance Ct is charged from the voltage Vcc (which is typically connected to the input supply voltage, Vin). When the voltage on CPVout falls below a minimum threshold, in this case around 4.5V, switches S1A and S1B are opened and S2A and S2B are closed, transferring a portion of the charge on Ct to Cdcpl. After the portion of the charge has transferred, S2A and S2B are opened and S1A and S1B re-closed.

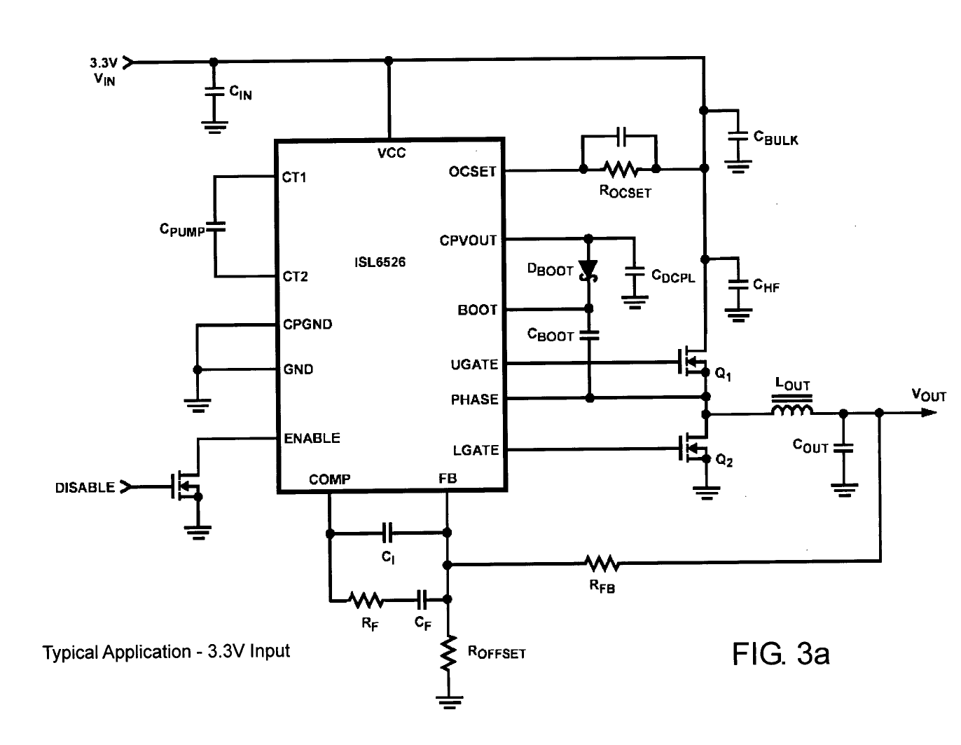

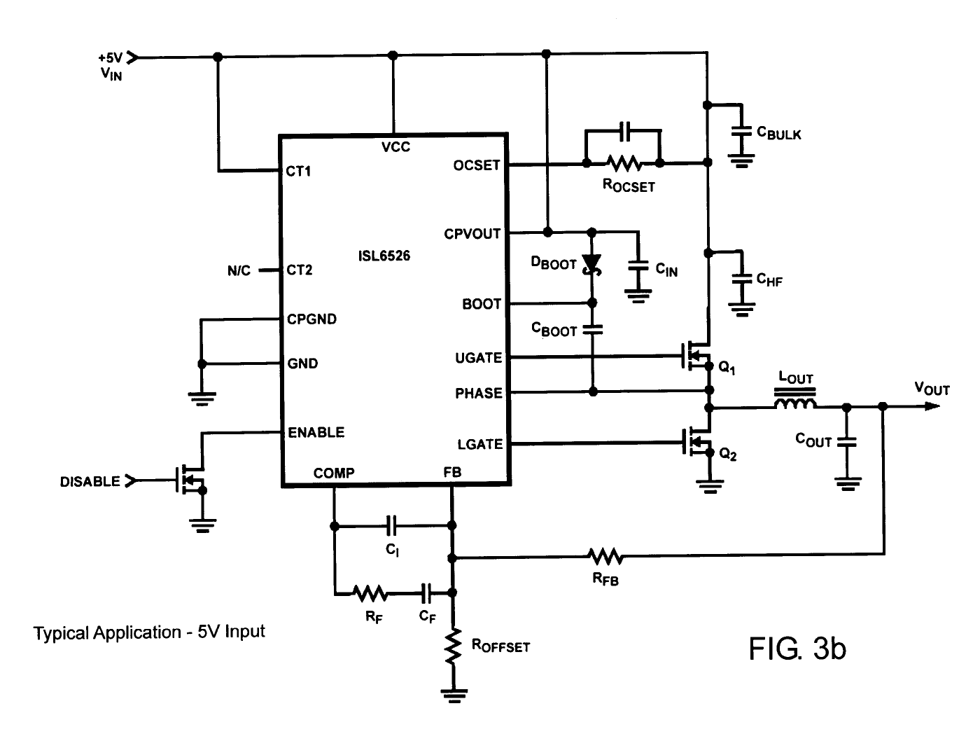

FIG. 3a shows a typical implementation of a Synchronous Buck DCDC Converter. Power MOSFETs Q1 and Q2 are turned on alternately, connecting Lout to either Vin or Ground. Lout and Cout form a 2^{nd}-order LC filter, smoothing the switching action of Q1 and Q2, and providing an essentially constant voltage, Vout. The value of Vout is sensed through Rfb, and the switching of Q1 and Q2 is adjusted by internal circuitry to hold Vout at a desired level. Components to affect the dynamics of the switching control and to disable the converter are also depicted in FIG. 3a; they are, however, irrelevant to the remainder of this discussion.

With Vcc<4.5V, as in the application of FIG. 3a, the charge pump is running normally and node CPVout will be at a higher voltage than Vcc. But if Vcc rises above CPVout, input signals can exceed their valid range causing improper operation of both the PWM IC and the power circuit. Furthermore, if the input voltage rises to more than a diode-drop above the CPVout minimum threshold of 5V, a junction internal to the PWM IC carries current at those valleys. This current also causes improper operation and can be destructive to the IC. For this reason the circuit of FIG. 3b, with Vcc tied directly to CPVout and the charge pump disconnected, is used for Vcc>4.5V. Obviously, the manufacturer did not foresee the desirability of using this PWM IC in a single device with a wide input voltage supply range.

It is desirable to have a method to allow CPVout to be pumped up above Vcc when Vcc is low and the charge pump is running, yet clamp CPVout to Vcc, preventing it from being significantly below Vcc, when Vcc rises above the CPVout minimum threshold. For the case of the ISL6526 control IC, CPVout should never be allowed to be more than 0.2V below Vcc.

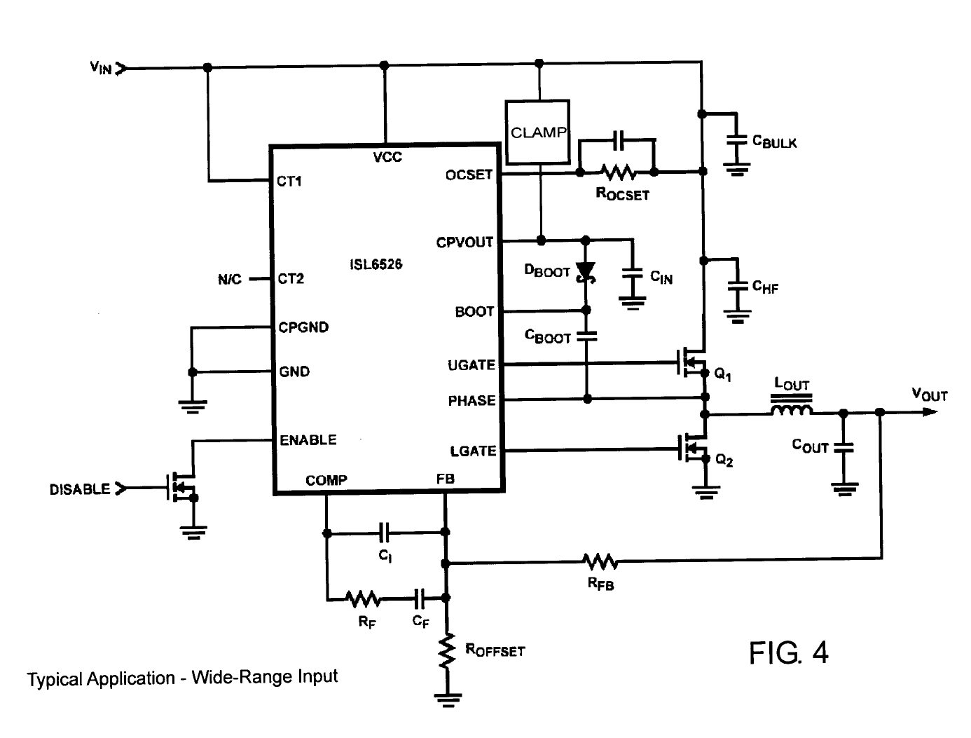

One method to accomplish this goal is to add a clamp from Vcc to CPVout as illustrated in FIG. 4 with an ISL6526 PWM controller in a synchronous buck converter.

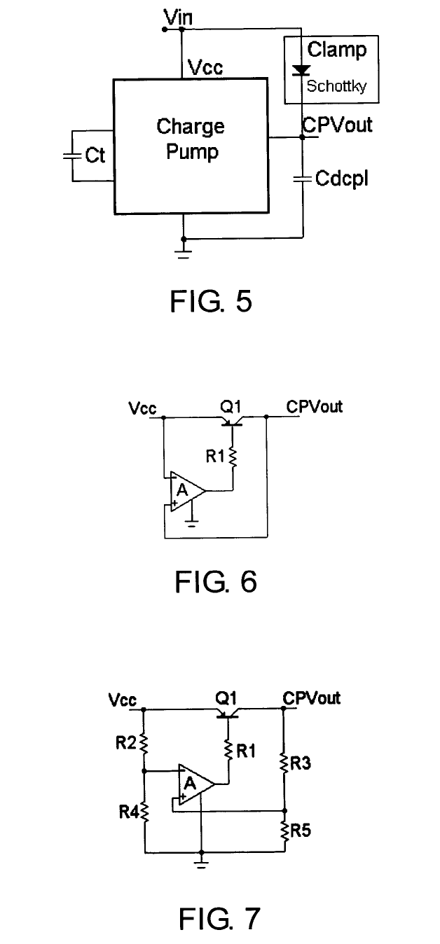

A simple implementation of that clamp can be a Schottky diode as shown in FIG. 5. Unfortunately, to achieve the low forward drop required to insure proper operation of the PWM IC, a rather large and expensive Schottky diode must be used. Schottky diodes of this size exhibit enough reverse leakage current at high temperatures to overload the charge pump at low input supply voltages, causing CPVout to droop unacceptably. Thus, even the relatively low forward drop of an acceptable Schottky diode is unsuitable to maintain proper operation of the IC at the high end of the input voltage range. A bipolar C-E junction is one example of a device that does provide sufficiently close clamping in this instance. And an amplifier or comparator provides an example of a way to control the junction.

FIG. 6 shows a simple amplifier-controlled bipolar clamp. The gain, A, and offset of the amplifier are designed so that when Vcc exceeds CPVout, Q1 is turned on and holds CPVout within a couple tenths of a volt (or a saturation drop) of Vcc. As Vcc drops below CPVout (and the charge pump begins running), the amplifier turns Q1 off.

The circuit of FIG. 6 might have difficulties with the common-mode range of its inputs. If required, both inputs could be divided as shown in FIG. 7. This also explicitly shows how the amplifier offset could be controlled via the relative resistor-divider ratios: R3,R5 and R2,R4.

In both the circuits of FIGS. 6 and 7, if the amplifier gain is increased to essentially infinity, a ‘comparator-based’ version results. In many instances this works just as well and is simpler to both design and implement.

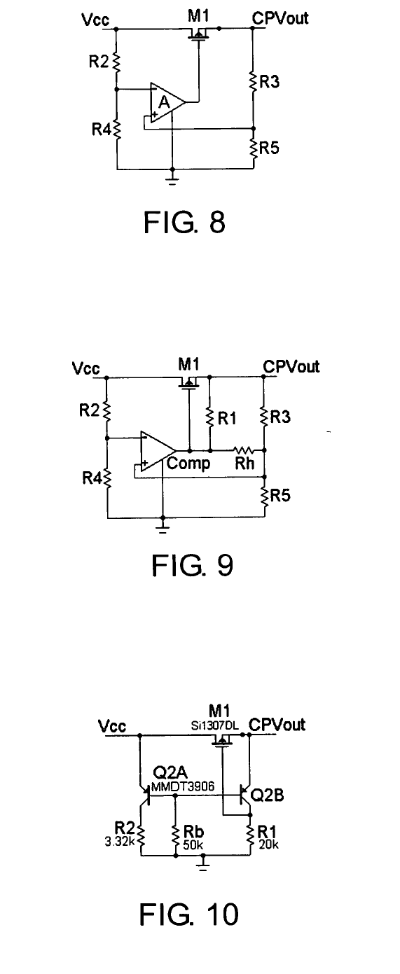

In both the circuits of FIGS. 6 and 7, when Q1 is off it is biased reverse of normal; that is, its collector is at a higher voltage than its emitter when it is turned off. This can be understood by remembering that when Vcc is low and the charge pump is running, CPVout is greater than Vcc. It is important that Q1 not leak so much in this mode that it overloads the charge pump and draws CPVout down. To alleviate leakage concerns, the circuit of FIG. 6 or FIG. 7 can also be modified to utilize a MOSFET as the clamp device, as illustrated generally by FIG. 8.

Again, by choosing the gain, A, and the offset via the resistor divider ratios, the turn-on of M1 can be designed to hold CPVout at greater than Vcc-0.1. For the case of the ISL6526, the 0.1V difference between Vcc and CPVout is sufficiently small to avoid damage to the control IC.

Again, the amplifier gain, A, can be increased so that a comparator is implemented and hard switching of M1 results. In this case the resistors should be chosen to set the switching threshold when Vcc exceeds CPVout by a small amount. If the threshold were set to be when the two voltages are equal, then once the switch turns on it might never turn off because the two inputs would be held roughly at equality forever.

Even so, with a small offset built in to the resistor dividers, the circuit of FIG. 8 contains negative feedback. It might therefore exhibit noise or oscillations near the transition points if a comparator is used. This problem can be solved trivially with some hysteresis. One simple method of accomplishing this hysteresis is shown in FIG. 9, where Rh is chosen to provide enough hysteresis to avoid noisy/oscillatory transitions.

FIG. 10 shows an implementation of a FIG. 6 type circuit, but with the MOSFET clamp device of FIG. 8. The amplifier is constructed with a common-base differential pair of PNP transistors. The two transistors can be combined in a common package and possibly matched so that their temperatures will be roughly equal and their temperature dependant parameters will therefore track.

Significantly, current is drawn from CPVout through R1 to hold M1 off when the charge pump is running. The charge pump must be able to supply this current that, with CPVout approaching 6V, will approach 300 uA. With the clamp transition happening when Vcc is near 4.5V and the threshold voltage of the MOSFET, M1, being typically between 1 and 3 volts, the transition will occur with the collector current of Q2B in the 100 uA range. Since Q2B is non-saturated at the transition and its Beta is typically near 100, Q2B's base current will on the order of 1 uA. Rb will, however, be drawing nearly 80 uA. The remaining 79 uA or so must come from the base of Q2A. If Q2A were also non-saturated, its collector current would be several milli-amps. But the value of R2 of 3.32 k dictates that only about 1.5 mA of collector current will saturate Q2A. With these circuit values, therefore, the clamp transition occurs with Q2A saturated. R2 limits the saturation current, and the base-current differential between Q2A and Q2B creates a small (50-100 mV) offset in the amplifier.

The clamp device will not be turned on until Vcc exceeds CPVout by 50-100 mV. This offset is important: perchance Q2A and Q2B exhibited an inherent mismatch in their base-emitter voltages such that Vbe(Q2A)<Vbe(Q2B) then when Vcc=CPVout, the clamp device, M1, may be turned on. M1 will then hold Vcc=CPVout forevermore, and the clamp will remain locked on.

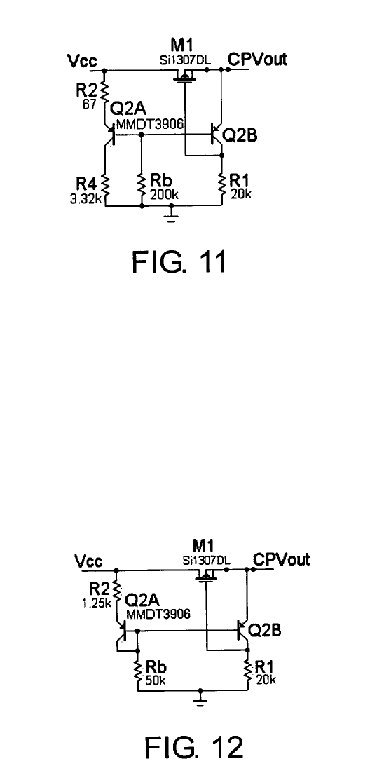

The implementation shown in FIG. 11 works similarly to that in FIG. 10. The transition occurs with Q2A saturated carrying an emitter-current of about 1.5 mA. This current must flow through R2 providing an additional 0.1V of offset.

The circuit of FIG. 12 is another variant of that shown in FIG. 10 that also includes an explicit offset. Q2B and Rb work as above, but Q2A, conducts the additional 79 uA of Rb current while connected as a diode. This 79 uA also flows through R2, requiring about 0.1 V, which is the design offset.

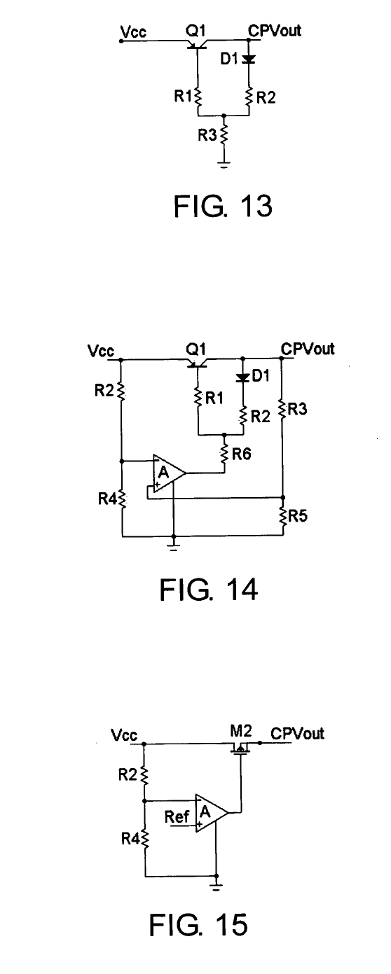

The circuit of FIG. 13 illustrates another slightly different approach. It can be said that the series combination of R1 and R3 holds the clamp switch, Q1, ‘normally-on’. But when CPVout exceeds Vcc, diode D1 will conduct through R2, raising the voltage across R3, lowering the voltage across R1, and therefore and shutting off Q1. It can be seen that with Vcc=CPVout, both devices, Q1 and D1, will be on, but that's inconsequential with the bipolar Q1. The resistors must be chosen such that, when CPVout exceeds Vcc by a couple tenths of a volt (and Q1 could begin conducting in reverse), Q1 should be fully off. This can be difficult to guarantee over all cases and temperatures and this circuit is likely to ‘leak’ significantly in reverse, when CPVout exceeds Vcc. Nonetheless it might prove entirely sufficient to the task. Diode D1 could itself be implemented in many ways, as a diode, a diode-connected transistor of either polarity, or even a reverse diode-connected transistor of either polarity.

Circuits of the type shown in FIG. 7 to FIG. 9 may have problems with the tolerances of the two resistor dividers. It may be difficult to insure that the switch is off when Vcc<CPVout, yet is on when Vcc exceed CPVout by 0.2V or so. The diode & resistor arrangement from FIG. 13 can be employed as in FIG. 14, for example, to help turn the switch off when Vcc is below CPVout thus making the tolerance of the resistor dividers less critical.

The examples thus far have all been efforts to construct an optimized version of the Schottky diode clamp shown in FIG. 5. The circuits looked at the Vcc-CPVout voltage and controlled a variably conducting device in response to it. There are myriad additional well-known circuits to construct idealized diodes, each with their own strengths, limitations, and costs. Anyone skilled in the art could arrive at several more workable solutions.

If the charge pump minimum threshold voltage is fairly well known, then the circuits could alternatively monitor Vcc and any handy reference (or a scaled version of it) instead of CPVout. FIG. 8 recast in this manner becomes FIG. 15.

Anyone skilled in the art can choose values for R2 and R4 to set the amplifier active region near the charge pump threshold. Anyone skilled in the art could also trivially employ a reference like this in any of the other implementations already presented; they will be omitted for brevity.

Of course the amplifiers and comparators of FIG. 6 to FIG. 9 can be constructed with any of a number of suitable integrated circuit OPAMPs or comparators, they could be constructed within the PWM IC itself, or they could be constructed with ‘discrete’ devices as illustrated in FIG. 10 to FIG. 12 for examples of a few. The discrete Q2A and Q2B in FIG. 10 to FIG. 12 are shown as PNP bipolar transistors. With appropriate biasing schemes, they could of course be NPN devices or MOSFETs of either polarity. Similarly the switches, Q1 and M1, in FIG. 6 to FIG. 14 could be any number of discrete devices of either polarity, they could be integrated circuit ‘CMOS Switches’, or they could be integrated in any of those forms within the PWM IC itself. The switches also needn't be directly controlled semiconductor devices; in some cases an electromagnetic relay or a photoconductive device could be gainfully employed.

While the circuit solutions shown in the document could be constructed external to the control IC, they could also be contained within the control IC.

This invention may be used in conjunction with “Charge Pump with Reduced Noise” filed on Jan. 26, 2004 with Thomas Farkas, Abram P. Dancy, Leif E. LaWhite and Martin F. Schlecht as inventors.

While this invention has been particularly shown and described with references to preferred embodiments thereof, it will be understood by those skilled in the art that various changes in form and details may be made therein without departing from the scope of the invention encompassed by the appended claims.

What is claimed is:

1. A charge pump circuit comprising:
charge pumping capacitance;
switches that vary voltage across the pumping capacitance to provide a pumped output voltage from an input voltage; and
a clamp circuit between the input and output to prevent the output voltage from being significantly below the input voltage.

2. A charge pump circuit as claimed in claim 1 wherein the clamp comprises a transistor.

3. A charge pump circuit as claimed in claim 2 wherein the transistor is controlled by a comparator.

4. A charge pump circuit as claimed in claim 3 wherein the comparator exhibits hysteresis.

5. A charge pump circuit as claimed in claim 2 wherein the transistor is controlled by an amplifier.

6. A charge pump circuit as claimed in claim 2 wherein the transistor is a field effect transistor.

7. A charge pump circuit as claimed in claim 1 included in a controller, the clamp circuit preventing the output voltage from being below the input voltage by an amount which would cause the controller to malfunction.

8. A charge pump circuit as claimed in claim 1 wherein the clamp circuit prevents the output voltage from being more than 0.2 volts below the input voltage.

9. A controller comprising:
charge pumping capacitance;
switches that vary voltage across the pumping capacitance to provide a pumped output voltage from an input voltage; and
a clamp circuit between the input and output to prevent the output voltage from being significantly below the input voltage.

10. A controller as claimed in claim 9 wherein the clamp comprises a transistor.

11. A controller as claimed in claim 10 wherein the transistor is controlled by a comparator.

12. A controller as claimed in claim 11 wherein the comparator exhibits hysteresis.

13. A controller as claimed in claim 10 wherein the transistor is controlled by an amplifier.

14. A controller as claimed in claim 10 wherein the transistor is a field effect transistor.

15. A charge pump circuit as claimed in claim 9 wherein the clamp circuit prevents the output voltage from being below the input voltage by an amount which would cause the controller to malfunction.

16. A charge pump circuit as claimed in claim 9 wherein the clamp circuit prevents the output voltage from being more than 0.2 volts below the input voltage.

17. A DC/DC converter comprising:
controlled switches; and
a controller that controls the controlled switches, the controller comprising:
charge pumping capacitance;
switches that vary voltage across the pumping capacitance to provide a pumped output voltage to the controller from an input voltage; and
a clamp circuit between the input and output to prevent the output voltage from being significantly below the input.

18. A DC/DC converter as claimed in claim 13 wherein the clamp comprises a transistor.

19. A DC/DC converter as claimed in claim 14 wherein the transistor is controlled by a comparator.

20. A DC/DC converter as claimed in claim 15 wherein the comparator exhibits hysteresis.

21. A DC/DC converter as claimed in claim 14 wherein the transistor is controlled by an amplifier.

22. A DC/DC converter as claimed in claim 14 wherein the transistor is a field effect transistor.

23. A charge pump circuit as claimed in claim 17 wherein the clamp circuit prevents the output voltage from being below the input voltage by an amount which would cause the controller to malfunction.

24. A charge pump circuit as claimed in claim 17 wherein the clamp circuit prevents the output voltage from being more than 0.2 volts below the input voltage.

25. A method of charge pumping comprising:
varying voltage across a pumping capacitance to provide a pumped output voltage from an input voltage; and
clamping the output voltage to prevent the output voltage from being significantly below the input voltage.

26. A method as claimed in claim 25 wherein the output voltage is clamped by a transistor between the input voltage and output voltage.

27. A charge pump circuit as claimed in claim 26 wherein the transistor is controlled by a comparator.

28. A charge pump circuit as claimed in claim 27 wherein the comparator exhibits hysteresis.

29. A charge pump circuit as claimed in claim 26 wherein the transistor is controlled by an amplifier.

30. A charge pump circuit as claimed in claim 26 wherein the transistor is a field effect transistor.

31. A method as claimed in claim 25 further comprising applying the pumped output voltage to a controller, the clamping preventing the output voltage from being below the input voltage by an amount which would cause the controller to malfunction.

32. A method as claimed in claim 25 wherein the clamping prevents the output voltage from being more than 0.2 Volt below the input voltage.

33. A method of converting DC voltage to DC voltage comprising:
varying voltage across a pumping capacitance to provide a pumped output voltage from an input voltage;
clamping the output voltage to prevent the output voltage from being significantly below the input voltage;
applying the output voltage to a controller; and
controlling converter switches from the controller.

34. A method as claimed in claim 33 wherein the output voltage is clamped by a transistor between the input voltage and output voltage.

35. A charge pump circuit as claimed in claim 34 wherein the transistor is controlled by a comparator.

36. A charge pump circuit as claimed in claim 35 wherein the comparator exhibits hysteresis.

37. A charge pump circuit as claimed in claim 34 wherein the transistor is controlled by an amplifier.

38. A charge pump circuit as claimed in claim 34 wherein the transistor is a field effect transistor.

39. A method as claimed in claim 33 wherein the clamping prevents the output voltage from being below the input voltage by an amount which would cause the controller to malfunction.

40. A method as claimed in claim 33 wherein the clamping prevents the output voltage from being more than 0.2 Volt below the input voltage.

41. A charge pump comprising:
means for varying voltage across a pumping capacitance to provide a pumped output voltage from an input voltage; and
means for clamping the output voltage to prevent the output voltage from being significantly below the input voltage.

42. A controller comprising:
means for varying voltage across a pumping capacitance to provide a pumped output voltage from an input voltage; and
means for clamping the output voltage to prevent the output voltage from being significantly below the input voltage.

43. A DC/DC converter comprising:
means for varying voltage across a pumping capacitance to provide a pumped output voltage from an input voltage;
means for clamping the output voltage to prevent the output voltage from being significantly below the input voltage;
means for applying the output voltage to a controller; and
means for controlling converter switches from the controller.
